(19) United States
(12) Patent Application Publication
(10) Pub. No.: US 2018/0345303 A1
(43) Pub. Date: Dec. 6, 2018

(54) ROTOR NOZZLE

(71) Applicant: Anton Jäger, Senden (DE)

(72) Inventor: Anton Jäger, Senden (DE)

(21) Appl. No.: 16/003,836

(22) Filed: Jun. 8, 2018

(30) Foreign Application Priority Data
May 17, 2017 (DE) 102017110765.7

(51) Int. Cl. B05B 3/04

(52) U.S. Cl. CPC B05B 3/0463

(57) ABSTRACT

A rotor nozzle for high pressure cleaning devices, having a nozzle housing that has an inlet opening at its axially one end and an outlet opening for liquid at the other end, and having a rotor which is arranged in the nozzle housing, whose front end facing the outlet opening is supported at a bearing, which may be at least partly flowed through by the liquid, and which may be set into rotation by liquid flowing into the nozzle housing. wherein the bearing has at least two bearing sides and may be placed into the nozzle housing in at least two different orientations in which the rotor is respectively supported at another one of the bearing sides.

### CROSS-REFERENCE TO RELATED APPLICATIONS

This application claims priority to German Patent Application No.: 102017110765.7 filed May 17, 2017, the entire contents of which are herein incorporated by reference.

### TECHNICAL FIELD

The present disclosure relates to a rotor nozzle, in particular for high pressure cleaning devices, having a nozzle housing that has an inlet opening at its axially one end and an outlet opening for liquid at the other end, and having a rotor which is arranged in the nozzle housing, whose front end facing the outlet opening is supported at a bearing, which can be at least partly flowed through by the liquid, and which can be set into rotation by liquid flowing into the nozzle housing.

### BACKGROUND

Rotor nozzles of this type are generally known. The bearing for the rotor is subject to not insubstantial wear. The user consequently has to keep replacement bearings in stock to be able to continue work with the rotor nozzle when a specific degree of wear of the bearing has been reached. A bearing then also has to be replaced with a bearing of a different size when work should be carried out with a rotor of a different size.

### SUMMARY

It is the object of the present disclosure to reduce the effort associated with a replacement of the bearing or to make it superfluous.

This object is satisfied by a rotor nozzle having a bearing that has at least two bearing sides and may be placed into the nozzle housing in at least two different orientations in which the rotor is respectively supported at another one of the bearing sides.

On wear to one of the bearing sides, it is only necessary in accordance with the present disclosure to place the bearing in a different orientation to bring the “new”, still unused bearing side into deployment. A replacement of the bearing is not required so that fewer replacement bearings, or none at all, have to be kept in stock. The service life of the bearing up to its replacement is hereby at least doubled.

In accordance with the present disclosure, the number of bearing sides provided at the bearing can generally be as desired. An even number of bearing sides is in particular provided, wherein the bearing sides oppose each other pairwise, and wherein the bearing sides of the or of each pair of bearing sides face in opposite directions. In other words, the bearing may have at least one pair of bearing sides facing in opposite directions.

In some embodiments, exactly two bearing sides facing in opposite directions are provided. In the wear case, the bearing consequently only has to be removed, turned by 180°, and replaced in this new orientation.

Such a bearing in accordance with the present disclosure may also be called a reversible bearing.

A single pair of oppositely oriented bearing sides is, however, not compulsory. It is generally also possible, for example, to configure the bearing in the manner of a dice having six bearing sides and thus three bearing side pairs.

In some embodiments, the bearing sides are of identical design.

Alternatively, the two bearing sides may have different sizes to be able to use a corresponding rotor of a different size on a use of the respective other bearing side.

In some other embodiments, the bearing sides are each designed as concave. Provision is in particular made that the bearing sides each flare outwardly in conical form, funnel form, or cup form.

In some embodiments, mutually oppositely disposed bearing sides open in opposite directions, and may be in conical, funnel, or cup form. The two bearing sides may in particular together form a shape in the manner of an hourglass.

In some embodiments, the rotating rotor expels a conical liquid jet, the bearing sides opening in opposite directions have the advantage that the discharge of the liquid jet is not disturbed by the bearing side respectively not used.

In some embodiments, at least one passage for liquid flowing out of the rotor may in particular—but not only—be provided between two bearing sides facing in opposite directions. A center axis of the passage in particular coincides with a center axis of the bearing and/or with a longitudinal axis of the nozzle housing.

When the bearing is, for example, provided with six bearing sides disposed opposite one another in pairs, a passage is present for each bearing side pair, with all the passages meeting at the center of the dice. In some embodiments, suitable sealing measures may be provided such that the liquid does not exit the bearing via the respective passages currently not being used during operation.

In some embodiments, the bearing is designed in one piece.

At least the bearing surfaces of the bearing sides directly cooperating with the rotor may consist of or comprise a ceramic material. In some embodiments, the total bearing is manufactured from a ceramic material.

The bearing may have a cylindrical base shape. In some embodiments, the bearing may have a circular cylindrical base shape. Such a base shape may be manufactured comparatively simply and facilitates the sealing.

In some embodiments, the bearing is provided with at least one peripheral groove for a seal.

Provision may furthermore be made that the nozzle housing has a seat for an exactly fitting reception of the bearing. It is hereby possible, for example, to press the bearing out of the seat through the inlet opening using a special tool or any desired suitable object.

In some embodiments, the bearing is removable and insertable via the end of the nozzle housing at the inlet side.

The present disclosure additionally relates to a bearing for a rotor nozzle of the kind described herein. The bearing has at least two bearing sides. Reference is made with respect to possible further developments of the bearing in accordance with the present disclosure to the above statements in connection with the rotor nozzle described herein.

Further embodiments of the present disclosure result from the claims, from the description, and from the Figures.

### BRIEF DESCRIPTION OF THE DRAWINGS

The present disclosure will be described in the following by way of example with reference to the drawing. There are shown:

FIG. 1 a side view of a rotor nozzle in accordance with an embodiment of the present disclosure;

FIG. 2 a longitudinal section through the rotor nozzle of FIG. 1;

FIG. 3 an enlarged representation of the region of the rotor nozzle of FIG. 2 at the outlet side; and

FIG. 4 a perspective view of a bearing for a rotor nozzle in accordance with the present disclosure.

### DETAILED DESCRIPTION

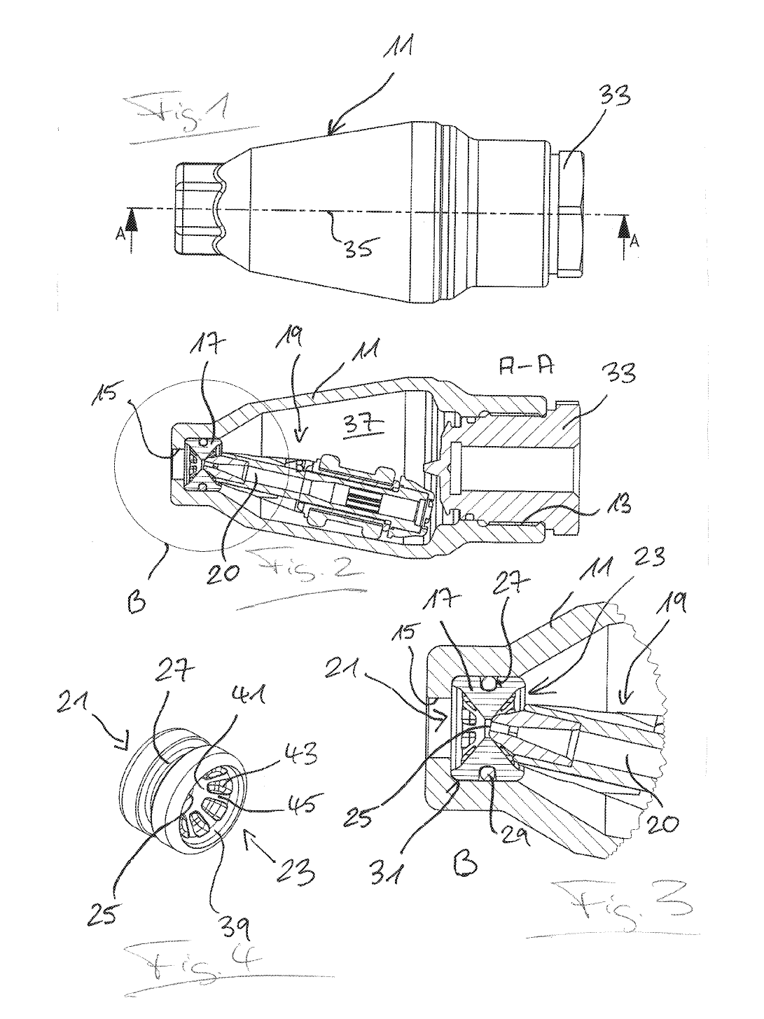

The rotor nozzle in accordance with the present disclosure shown in FIGS. 1, 2, and 3 comprises a nozzle housing 11 which in some embodiments is manufactured from metal, which is substantially rotationally symmetrical with respect to a longitudinal axis 35, and in which a rotor space 37 also called a swirl chamber is formed.

When a plug 33 is screwed into the rear end of the nozzle housing 11 via which the rotor nozzle may be connected in a manner known per se to a supply line, for example in the form of a so-called lance that may in turn be connected to a high pressure cleaning device that supplies a liquid, such as water, to the rotor nozzle at high pressure. The pressurized liquid enters via one or more bores, not shown, in the plug 33 into the rotor space 37 such that an eddy flow is created and thereby a rotor 19 arranged in the rotor space 37 is set into rotation about the longitudinal axis 35.

This functional principle of a rotor nozzle is familiar to the skilled person so that is does not need to be looked at more closely here.

A seat 31 for a bearing 17 also shown in FIG. 4 is formed in the region of a front outlet opening 15 in the nozzle housing 11 and is arranged with an exact fit in the seat 31 during operation and is supported at a shoulder bounding the outlet opening 15.

The bearing 17 that is formed in one piece and in which in some embodiments is manufactured from a ceramic material has a circular cylindrical base shape that is outwardly provided with a peripheral groove 27 (cf. FIG. 4) that serves for the reception of an O ring seal 29 (cf. FIG. 3), whereby it is prevented that the liquid moves outwardly past the bearing 17 to the outlet opening 15 in the region of the seat 31 during operation.

The bearing 17 is designed as a reversible bearing that has two identical bearing sides 21, 23 that each have a cup-like recess having a centrally arranged bearing surface for the front end of the rotor 19. The two bearing sides 21, 23 are connected to one another via a passage 25. The bearing surface is formed by an inner ring region 41 that concentrically surrounds the passage 25 and an outer ring region 39. The inner ring region 41 and the outer ring region 39 are connected to one another by webs 45 between which recesses 43 are formed. These recesses 43 are not openings, i.e. the two bearing sides 21, 23 are only connected to one another via the central passage 25. The recesses 43 may facilitate the manufacture of the bearing 17. In general, such recesses 43 may be dispensed with and the bearing sides 21, 23 may each be formed as smooth.

In the embodiment shown, the bearing 17 is designed as symmetrical with respect to a plane that is defined by the peripheral groove 27 and thus extends perpendicular to the center axis of the cylindrical base shape of the bearing 17 and thus perpendicular to the longitudinal axis 35 of the nozzle housing 11 with an inserted bearing 17.

During operation, the rotor 19 runs on a cone about the longitudinal axis 35, with the rotor 19 rolling off and/or sliding at the conical inner wall of the nozzle housing 11 in dependence on the respective circumstances. Depending on the specific design of the rotor nozzle, the rotor 19 may additionally carry out a rotation about its own longitudinal axis. The liquid flowing through an inner channel 20 of the rotor 19 to its front end forms a conical jet exiting the outlet opening 15 with a rotor 19 rotating in this manner. The kinematics of such a rotor nozzle that are generally familiar to the skilled person do not need to be looked at in any more detail at this point.

The movement of the rotor 19 during operation results in wear of the respectively used bearing side and in this respect in particular of the bearing surface 41. To put the respective other bearing side into operation in the wear case, the bearing 17 may be urged via the outlet opening 15 into the rotor space 37 and may be removed via the inlet opening 13 after removal of the plug 33 or may be gripped by a tool or by hand and may be arranged in the seat 31 again in the corresponding new orientation.

The service life of the rotor nozzle before the bearing 17 has to be replaced with a new bearing is hereby doubled.

1. A rotor nozzle comprising:
a nozzle housing that has an inlet opening at its axially one end and an outlet opening for liquid at the other end; and
a rotor which is arranged in the nozzle housing, whose front end facing the outlet opening is supported at a bearing, which is configured to be flowed through at least partly by the liquid, and which is configured to be set into rotation by liquid flowing into the nozzle housing,
wherein the bearing has at least two bearing sides and is configured to be placed into the nozzle housing in at least two different orientations in which the rotor is respectively supported at another one of the bearing sides.

2. The rotor nozzle in accordance with claim 1, wherein the bearing is designed as a reversible bearing.

3. The rotor nozzle in accordance with claim 1, wherein the bearing has an even number of bearing sides that oppose each other pairwise, wherein the bearing sides of the or of each pair of bearing sides face in opposite directions.

4. The rotor nozzle in accordance with claim 1, wherein the bearing sides are each designed as concave.

5. The rotor nozzle in accordance with claim 1, wherein the bearing sides are of identical design.

6. The rotor nozzle in accordance with claim 1, wherein a passage for liquid flowing out of the rotor is provided between the two bearing sides.

7. The rotor nozzle in accordance with claim 1, wherein the bearing is provided with a peripheral groove for a seal.

8. The rotor nozzle in accordance with claim 1, wherein the nozzle housing has a seat for an exactly fitting reception of the bearing.

9. The rotor nozzle in accordance with claim 1, wherein the bearing is removable and insertable via the end of the nozzle housing at the inlet side.

10. (canceled)

11. The rotor nozzle in accordance with claim 4, wherein the bearing sides are each designed as to flare outwardly in conical form, funnel form, or cup form.

12. A bearing for use in a rotor nozzle comprising:
a nozzle housing that has an inlet opening at its axially one end and an outlet opening for liquid at the other end; and
a rotor which is arranged in the nozzle housing, which is configured to be flowed through at least partly by the liquid, and which is configured to be set into rotation by liquid flowing into the nozzle housing,
the bearing comprising:
at least two bearing sides configured to be placed into the nozzle housing in at least two different orientations in which a front end of the rotor facing the outlet opening is respectively supported at the bearing sides.

13. The bearing in accordance with claim 12, wherein the bearing is designed as a reversible bearing.

14. The bearing in accordance with claim 12, wherein the bearing has an even number of bearing sides that oppose each other pairwise, wherein the bearing sides of the or of each pair of bearing sides face in opposite directions.

15. The bearing in accordance with claim 12, wherein the bearing sides are each designed as concave.

16. The bearing in accordance with claim 12, wherein the bearing sides are of identical design.

17. The bearing in accordance with claim 12, wherein a passage for liquid flowing out of the rotor is provided between the two bearing sides.

18. The bearing in accordance with claim 12, wherein the bearing is provided with a peripheral groove for a seal.

19. The bearing in accordance with claim 12, wherein the nozzle housing has a seat for an exactly fitting reception of the bearing.

20. The bearing in accordance with claim 12, wherein the bearing is removable and insertable via the end of the nozzle housing at the inlet side.

21. The bearing in accordance with claim 15, wherein the bearing sides are each designed as to flare outwardly in conical form, funnel form, or cup form.
